(19) United States
(12) Patent Application Publication
(10) Pub. No.: US 2021/0192803 A1
(43) Pub. Date: Jun. 24, 2021

(54) System and method for arranging warehouse bins visually

(71) Applicant: INDUSTRIAL TECHNOLOGY RESEARCH INSTITUTE, Hsinchu (TW)

(72) Inventors: Li-Yi Liu, Hsinchu (TW); Li-Te Huang, Hsinchu (TW)

(21) Appl. No.: 16/720,247

(22) Filed: Dec. 19, 2019

(51) Int. Cl. G06T 11/00; G06F 16/245; G06Q 10/08; G06Q 10/04

(52) U.S. Cl. CPC G06T 11/001; G06F 16/245; G06Q 10/067; G06Q 10/04; G06Q 10/087

(57) ABSTRACT

A method for arranging warehouse bins visually is provided, including: providing product basic data and warehouse space data; normalizing the product basic data based on product characteristics to generate normalized product data; generating product color information corresponding to a product status based on the normalized product data; generating warehouse structure information corresponding to a warehouse status based on the warehouse space data; and combining the product color information with the warehouse structure information to obtain visualized warehouse bins arrangement status when the product color information is added to the warehouse structure information. A system for arranging warehouse bins visually that allows the above method to be applied thereto is also provided.

### TECHNICAL FIELD

The present disclosure relates to warehouse bins arranging techniques, and, more particularly, to a system and method for arranging warehouse bins visually.

### BACKGROUND

At present, the issues related to the preparation and warehouse of goods in the logistic industry have attracted the attention of the industry. Different from the manual planning and management of traditional warehouse management, modern warehouse management mostly cooperates with information processing, which speeds up the management and reduces the labor. However, warehouse management still faces many difficulties. For example, popular and unpopular products cannot be adjusted in real-time with fluctuations in sales volume; similar product appearances lead to error in picking; high turnover rate products are placed far from the exit, resulting in poor picking rates; and during the picking process light products are pressed by heavy products and are likely to be damaged. The foregoing issues illustrate the importance of warehouse bins arrangement.

With regard to the management, most of the current warehouse management systems provide operation screens and statistical report data to warehouse operators and managers. However, the warehouse status of text or numbers is not intuitive enough, which causes warehouse operators or managers to not notice warehouse status issues directly. For example, when various types of products are stored in the warehouse, as the products are sold, the number of each item decreases, which quantity needs to be replenished will become the first question; under the same space size, the number of large and small commodities can be placed differently; considering the inventory of products, there may be distortion, so this type of management must consider the relationship between the size of the products and the volume of the storage space. Commodity inventory is presented in numbers, which is just an icy number for warehouse operators or managers. There are 100 or 50 left in stock. Such inventory is not intuitive. Warehouse operators or managers are easily negligent and forget to replenish. For example, the maximum inventory or products is 100 but the current number of products is 5, and the maximum inventory of products is 10 but the current number of products is 5. Both products have 5 remaining, but the urgency of replenishment may be very different. Therefore, it is necessary to quickly and intuitively know the current status of the warehouse.

Storage space arrangement is also important for storage management. For example, newcomers cannot quickly schedule warehouse bins on shelves because they cannot consider the multiple characteristics of the product and the warehouse bins arrangement at the same time. In short, the product characteristics affect the storage location of products in the warehouse.

### SUMMARY

The objective of the present disclosure is to enable managers to quickly know the warehouse bins arrangement status via a visualized system interface, so as to determine whether the warehouse bins arrangement status meets the requirements, thereby solving the problem that existing warehouse management cannot intuitively know the warehouse arrangement status.

A system for arranging warehouse bins visually is provided, comprising: a calculation module configured for normalizing product basic data based on product characteristics to generate normalized product data; a warehouse module configured for storing the normalized product data; and a visualization module, comprising: a color transformation unit configured for generating product color information corresponding to a product status based on the normalized product data; a warehouse space data transformation unit configured for generating warehouse structure information corresponding to a warehouse status based on warehouse space data; and a warehouse structure drawing unit configured for combining the product color information with the warehouse structure information to obtain an arrangement status of visualized warehouse bins.

A method for arranging warehouse bins visually is also provided, comprising: providing product basic data and warehouse space data; normalizing the product basic data based on product characteristics to generate normalized product data; generating product color information corresponding to a product status based on the normalized product data; generating warehouse structure information corresponding to a warehouse status based on the warehouse space data; and combining the product color information with the warehouse structure information to obtain visualized warehouse bins arrangement status when the product color information is added to the warehouse structure information.

It is known from the above that in the system and method for arranging warehouse bins visually according to the present disclosure, the visualized warehouse bins arrangement status generated finally allows personal to analyze, manage and optimize the warehouse bins arrangement intuitively. In the system for arranging warehouse bins visually according to the present disclosure, every aspect of the product data can be analyzed in real-time in more than one dimension. After the warehouse space data and the product basic information are analyzed and calculated, the attribute value of every aspect is represented with a color graph. The arrangement of warehouse bins can be further optimized by artificial intelligence (AI) techniques or an empirical law, so as to provide visualized warehouse bins arrangement and optimized warehouse management.

### BRIEF DESCRIPTION OF DRAWINGS

FIG. 1 is a functional block diagram of a system for arranging warehouse bins visually according to the present disclosure.

FIG. 2 is a functional block diagram of a system for arranging warehouse bins visually of another embodiment according to the present disclosure.

FIG. 3 is a flow chart illustrating a method for arranging warehouse bins visually according to the present disclosure.

FIGS. 4A to 4C are functional block diagrams illustrating the operation of a system for arranging warehouse bins visually according to the present disclosure.

FIG. 5 illustrates normalization of product basic data according to the present disclosure.

FIG. 6 schematically illustrates a first embodiment relating to arranging warehouse bins visually according to the present disclosure.

FIG. 7 schematically illustrates a second embodiment relating to arranging warehouse bins visually according to the present disclosure.

FIG. 8 schematically illustrates a third embodiment relating to arranging warehouse bins visually according to the present disclosure.

FIG. 9 schematically illustrates a fourth embodiment relating to arranging warehouse bins visually according to the present disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

According to the present disclosure, modules, units and devices comprise microprocessor and memory, algorithms, data and programs are stored in memory or chips, and microprocessors can load data, algorithms and programs from memory and analyze and calculate the data. In an embodiment according to the present disclosure, a calculation module, a warehouse module and a visualization module comprise a microprocessor and memory, each unit in each module analyzes and calculates, and the hardware of the unit and module is realized in the same manner.

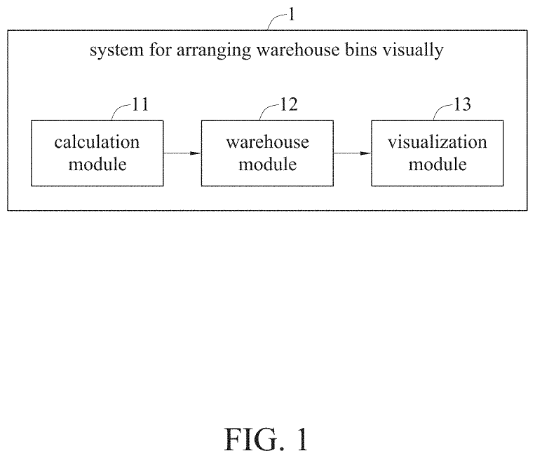

FIG. 1 is a functional block diagram of a system 1 for arranging warehouse bins visually according to the present disclosure. The system 1 for arranging warehouse bins visually according to the present disclosure provides a representation mechanism for visualizing warehouse arrangement statuses, and, in practice, warehouse managers can manage the arrangement characteristics of the warehouse bins in real time, find out the bottleneck, and change the whole warehouse bins arrangement. Therefore, the warehouse manager can analyze the characteristics of every aspect of the current arrangement, and control the use of the warehouse bins. As shown in FIG. 1, the system 1 comprises a calculation module 11, a warehouse module 12 and a visualization module 13.

The calculation module 11 normalizes product basic data based on product characteristics to generate normalized product data. Normalizing data means scaling the data to be within a small certain range. During the normalization, the unit of the data is ignored, and different units are converted into a value without any unit. For example, kilogram and cubic meter are converted into a value ranging from 0 to 1. Therefore, indexes in different units or scales can be compared and weighted. In order to analyze the relation between each of the warehouse bins and products clearly, the products have to be analyzed. In the beginning, product basic data are obtained and analyzed based on product characteristics. In an embodiment, the product characteristics are turnover rate, weight or volume. The size of a product is highly correlated to the number of the product that can be placed in the warehouse bins, and is the basis for the manager to replenish the product. The weight of a product is an important reference for the manager to pick and place the product. The turnover rate of a product is a reference taken by the manager to determine which warehouse bin where the product is placed. Therefore, it is necessary to understand products through their product characteristics. The calculation module 11 may use a product characteristics normalized matrix to normalize the product basic data, and obtain valuable data for subsequent performance of a visually processing process. The normalization will be described in the following paragraphs.

The warehouse module 12 stores the normalized product data. The normalized product data generated by the calculation module 11 will be stored in the warehouse module 12. The products will be analyzed, and the warehouse bins status will be analyzed as well. Therefore, the normalized product data is stored in the warehouse module 12 temporarily, and will be used in the subsequent visually processing process. In an embodiment, the warehouse module 12 is a register that stores data temporarily or a readable/writeable memory (RAM).

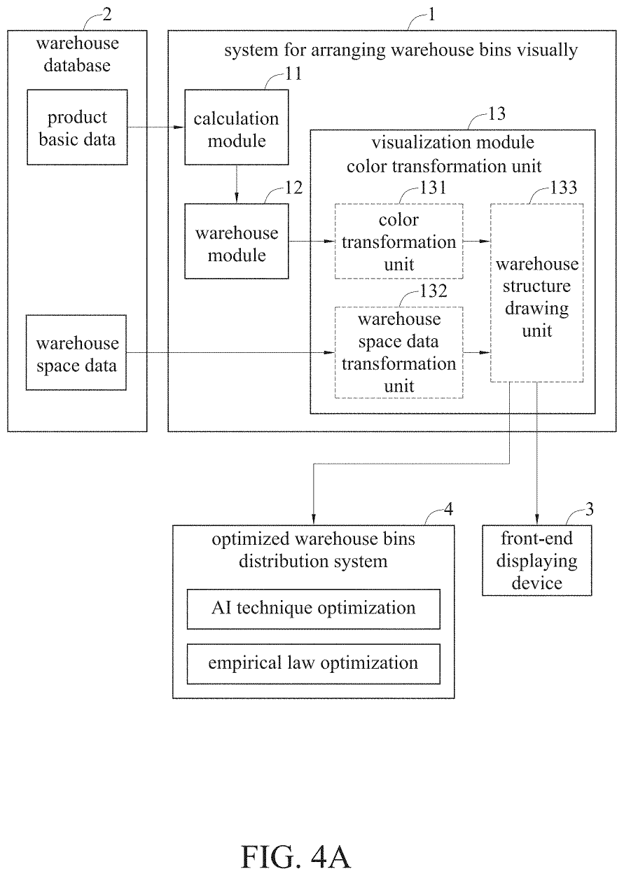

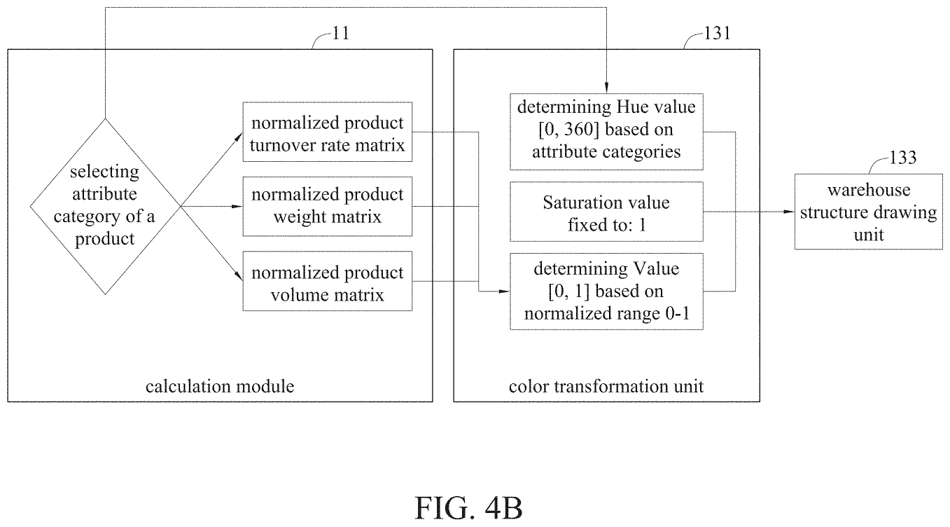

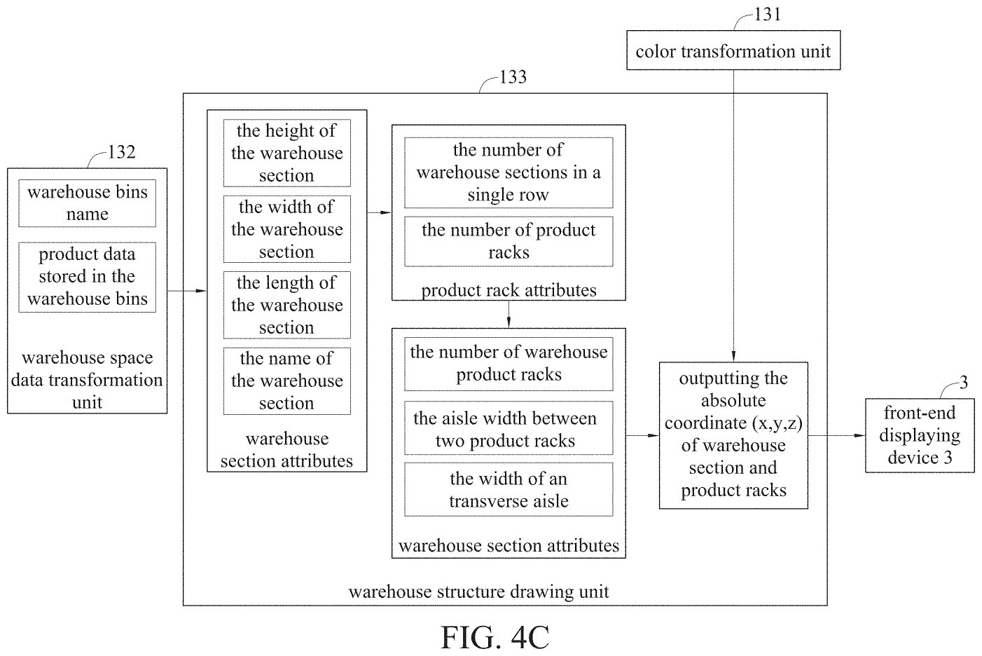

Please also refer to FIG. 4A. The visualization module 13 comprises a color transformation unit 131, a warehouse space data transformation unit 132 and a warehouse structure drawing unit 133. The color transformation unit 131 generates product color information corresponding to a product status based on the normalized product data. The warehouse space data transformation unit 132 generates warehouse structure information corresponding to a warehouse status based on warehouse space data. The warehouse structure drawing unit 133 combines the product color information with the warehouse structure information to obtain visualized warehouse bins arrangement status. The visualization module 13 is used for performing data visualizing process, and comprises a color transformation unit 131, a warehouse space data transformation unit 132 and a warehouse structure drawing unit 133. The color transformation unit 131 analyzes the normalized product data to enable a product to generate a corresponding color based on a product status, i.e., giving product color information. The warehouse space data transformation unit 132 generates warehouse structure information based on warehouse space data. The warehouse structure information generates warehouse statuses of the whole warehouse based on the warehouse space data. In an embodiment, the warehouse statuses include the length, width and height of the warehouse bins, an aisle width, the number of product racks and the number of warehouse bins. The warehouse structure drawing unit 133 combines the product color information with the warehouse structure information, such that color of a corresponding product status is substituted in the warehouse structure information to generate visualized warehouse bins arrangement status. The visualized warehouse bins arrangement status is visualized information related to warehouse bins arrangement.

In an embodiment, the normalized product data is an attribute value ranging from 0 to 1, and the color transformation unit 131 represents a difference of the product characteristics based on the attribute value with different color. After normalization, the products in each warehouse bin are represented by a value ranging from 0 to 1, and the value corresponds to a color, e.g., cardinal red, bright red, dark red, light red etc., based on different attributes, e.g., turnover rate, weight, volume etc., and the color transformation unit 131 represents the difference of the product characteristics based on the attribute value with different color.

In another embodiment, the warehouse structure drawing unit 133 substitutes the product color information representing the product status into the warehouse structure information representing the warehouse status, so that the warehouse bins of the warehouse structure information are represented with different color based on the difference of the product characteristics. The warehouse structure drawing unit 133 combines the product color information, which represents product status, with the warehouse structure information, which represents warehouse status. After the combination by the warehouse structure drawing unit 133, a visualized graph can be drawn, and the product statuses of warehouse bins are represented with different color based on the warehouse statuses.

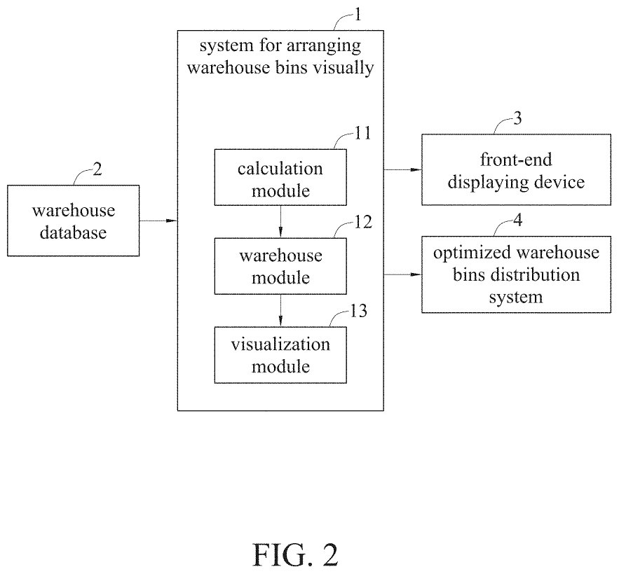

FIG. 2 is a functional block diagram of a system 1 for arranging warehouse bins visually of another embodiment according to the present disclosure. As shown in FIG. 2, the system 1 has the calculation module 11, the warehouse module 12 and the visualization module 13, which are shown in FIG. 1. The system 1 is further connected to a warehouse database 2, a front-end displaying device 3 and an optimized warehouse bins distribution system 4.

The warehouse database 2 stores product basic data and warehouse space data. Since the system 1 will analyze data and perform the subsequent visually processing process, the product basic data and warehouse space data that the system 1 needs may be stored in the warehouse database 2. The product basic data can be input by the warehouse manager. The warehouse space data can define the size of the space and the location relationship of the warehouse bins through a drawing software. Therefore, when arranging the warehouse bins, the system 1 can obtain corresponding data from the warehouse database 2.

The front-end displaying device 3 displays the visualized warehouse bins arrangement statuses generated by the warehouse structure drawing unit 133 with a color graph. In order for the warehouse manager to understand the warehouse bins arrangement statuses of the whole warehouse intuitively and quickly, the present disclosure uses a color graph to display the visualized warehouse bins arrangement statuses obtained after the system 1 calculates and analyzes. Color is used to represent the product data status of each of the warehouse bins, e.g., the number, the volume and the turnover rate. In an embodiment, the front-end displaying device 3 is a displaying device of any type.

The optimized warehouse bins distribution system 4 optimizes the warehouse bins arrangement. In an embodiment, the optimized warehouse bins distribution system 4 optimizes the warehouse bins arrangement by integrating a plurality of messages. In another embodiment, the optimized warehouse bins distribution system 4 determines the number of new products that have to be stocked based on prediction data, Internet sentiments of the products, weather data and timing data. Therefore, the number of the new products can be adjusted according to peak/off season, weather, holidays, product basic data, appearance similarity and product price difference, to avoid that highly related products are placed from one another distantly, products that are very similar and hard to distinguish are placed close to one another, and products that have a large price gap are neighbored. The product basic data and the history order data can be integrated, to avoid that products that have a high turnover rate are placed far from the entrance and exit and the heavy products are placed on the light products. The optimized warehouse bins distribution system 4 allows the warehouse manager to manage the product effectively. The techniques about the optimized warehouse bins distribution system 4 are described in Taiwanese Patent Application No. 107130601, filed on Aug. 31, 2018.

The system 1 for arranging warehouse bins visually according to the present disclosure can be implemented on an electronic apparatus, such as a computer, a tablet computer or a server. The system 1 for arranging warehouse bins visually obtains, analyzes and calculates data from the warehouse database 2 through software and an electronic apparatus that has a processor, memory etc. In an embodiment, the calculation module 11, the warehouse module 12 and the visualization module 13 of the system 1 are composed of individual components, such as calculators, memory, storage or firmware having a processing unit. In another embodiment, the color transformation unit 131, the warehouse space data transformation unit 132 and the warehouse structure drawing unit 133 are implemented by software, hardware or firmware.

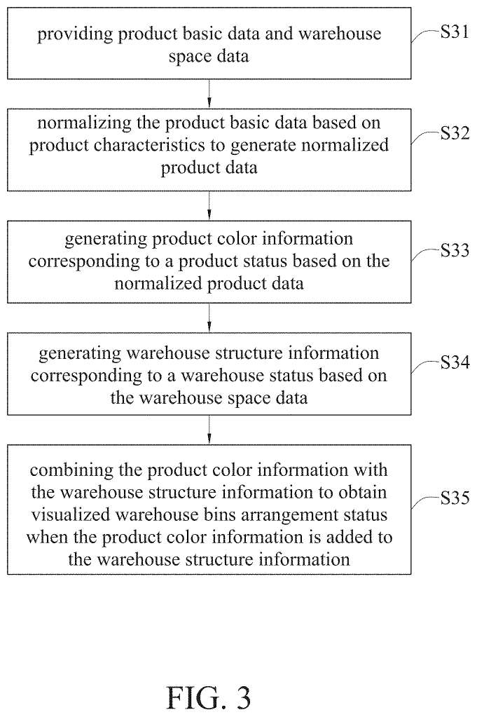

FIG. 3 is a flow chart illustrating a method for arranging warehouse bins visually according to the present disclosure. In step S31, product basic data and warehouse space data are provided. Step S31 is performed in order to know the relation between warehouse bins and products, and, as such, the product basic data and the warehouse space data have to be obtained. The product basic data records product information, such as size and amount, and the warehouse space data is the statuses of the warehouse bins, such as the length, width and height of the warehouse bins, an aisle width, the number of product racks and the number of the warehouse bins.

In step S32, the product basic data is normalized based on product characteristics, and normalized product data is generated. In step S32, a product characteristics normalized matrix is used to normalize the product basic data, to obtain valuable data for subsequent execution of a visually processing process. In an embodiment, the product characteristics include a turnover rate, weight and volume. The volume of a product correlates to a number of the products to be placed in the warehouse bins. Picking order and placement of a product are determined by reference to the weight of the product. The placement of a product is determined by reference to its turnover rate. In an embodiment, the product basic data are normalized, and the value obtained after normalization will be analyzed and applied easily.

In an embodiment, the normalized product data is an attribute value ranging from 0 to 1, and different attribute values represent the difference of the product characteristics with different color. After the normalization, the attribute value will be a value ranging from 0 to 1, and each of the value range corresponds to a certain color. In an embodiment, the attribute value ranging from 0.9 to 1 is the darkest color, the attribute value ranging from 0.8 to 0.9 is the second darkest color, and so on, and the attribute value ranging from 0 to 0.1 is the lightest color.

In step S33, product color information corresponding to a product status is generated based on the normalized product data. In step S33, the product generates corresponding color based on the product status by analyzing the normalized product data. In other words, the product color information is given based on the normalized product data. In an embodiment, the attribute is weight, the first 20% heavier products use deep red and the first 20% to 40% heavier products use dark red. Through the above color representation, the warehouse manager can see the warehouse bins arrangement status intuitively.

In step S34, warehouse structure information corresponding to a warehouse status is generated based on the warehouse space data. In step S34, the warehouse space data transformation unit 132 generates the warehouse structure information based on the warehouse space data. In an embodiment, the warehouse status is the length, width and height of the warehouse bins, an aisle width, the number of product racks and the number of the warehouse bins. Since the products and the warehouse bins are displayed with a color graph, it is necessary to obtain the warehouse structure information.

In step S35, the product color information is combined with the warehouse structure information to obtain visualized warehouse bins arrangement status when the product color information is added to the warehouse structure information. In step S35, the warehouse structure drawing unit 133 combines the product color information and the warehouse structure information by substituting color of a corresponding product status into the warehouse structure information to generate the visualized warehouse bins arrangement status, i.e., visualized information about the warehouse bins arrangement.

The above step substitutes the product color information representing the product status into the warehouse structure information representing the warehouse status, and the warehouse bins of the warehouse structure information are represented with different color based on the difference of the product characteristics.

In another embodiment, the visualized warehouse bins arrangement status is transmitted to a front-end displaying device. Since the visualized warehouse bins arrangement status represented by a color graph will be generated, the visualized warehouse bins arrangement status can be transmitted to the front-end displaying device to be checked by the warehouse manager.

In another embodiment, the visualized warehouse bins arrangement status is transmitted to an optimized warehouse bins distribution system that optimizes the warehouse bins arrangement. In order for the warehouse bins arrangement to meet requirements, the visualized warehouse bins arrangement status can be transmitted to the optimized warehouse bins distribution system for warehouse bins optimization. The optimized warehouse bins distribution system optimizes the warehouse bins arrangement by considering products, warehouse, and a variety of messages, such as Internet sentiments of the product, weather data and timing data, which are used as a reference to preparation of products. In an embodiment, the warehouse bins arrangement is optimized based on the product appearance similarity and product price difference, to avoid that the highly related products are placed far away from one another, products that are very similar and hard to distinguish are placed together, and neighboring products have a large price gap. In an embodiment, the product basic data and history order data are integrated, to avoid products that have a high turnover rate are placed far away from the entrance or exit and the heavy products are placed on the light products. Therefore, the visualized warehouse bins arrangement status can be transmitted to the optimized warehouse bins distribution system 4 to further manage the product arrangement effectively.

FIGS. 4A to 4C are functional block diagrams illustrating the operation of a system for arranging warehouse bins visually according to the present disclosure. As shown in FIG. 4A, the system 1 for arranging warehouse bins visually is connected to the warehouse database 2, the front-end displaying device 3 and the optimized warehouse bins distribution system 4. The warehouse database 2 stores the product basic data and the warehouse space data.

The calculation module 11 of the system 1 normalizes the product basic data. The calculation module 11 normalizes the product basic data through the product characteristics normalized matrix. The calculation of the product characteristics normalized matrix includes obtaining an N*1 product attribute matrix from the attributes of the product basic data (e.g., weight, turnover rate etc.), obtaining the maximum value and the minimum value of the elements in the product attribute matrix from the product attribute matrix, subtracting all of the element in the product attribute matrix by the minimum value, and dividing the elements by the maximum value subtracted by the minimum value, to obtain the normalized product attribute values, all of which range from 0 to 1.

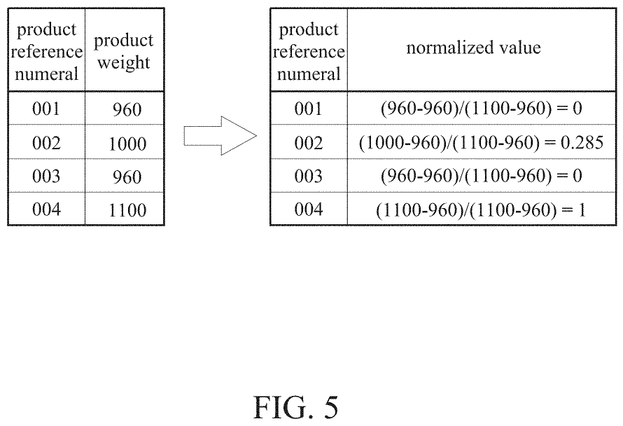

The calculation of the product characteristics normalized matrix is shown in FIG. 5. In an embodiment, a first product 001 weighs 960 grams, a second product 002 weighs 1,000 grams, a third product 003 weighs 960 grams, a fourth product 004 weighs 1100 grams, the maximum value in the thus obtained matrix is 1,100 grams, and the minimum value is 960 grams; all the elements in the matrix are subtracted by the minimum value (i.e., 960 grams), and divided by the maximum value (i.e., 1100 grams) subtracted by the minimum value (i.e., 960 grams), to obtain the product attribute values, such as 1, 0 or 0.285, which indicate the relative weight relation of the products. The products are not categorized or analyzed by their direct values.

It is known from the above that the normalized product data is an attribute value ranging from 0 to 1 and can be stored in the warehouse module 12. The visualized warehouse bins arrangement status of a color graph can be generated by the visualization module 13. The visualization module 13 comprises a color transformation unit 131, a warehouse space data transformation unit 132 and a warehouse structure drawing unit 133. The color transformation unit 131 uses different color to represent the difference of the product characteristics. In an embodiment, the color transformation unit 131 normalizes the product basic data to be an attribute value ranging from 0 to 1, and differentiates the different color by substitution of color brightness. The different color is used to represent the difference of the product characteristics (e.g., turnover rate, weight and volume) at the location.

In an embodiment, the color transformation unit 131 performs the calculation through the attribute values normalized from the product basic data and attribute categories of the products. The HSV color space transformation is used as an example. FIG. 4B illustrates the color transformation process, without considering data storage or stored temporarily. The HSV color space includes a hue value (Hue value), a degree of saturation (Saturation value) and a brightness value (Value). Every product attribute is given its own unique Hue value, which relates to hue of color, in the unit of degree, e.g., 0 to 360 degrees. Every specific color has its own unique hue. For example, red is 0 degree, and green is 120 degrees. The color transformation unit 131 determines a Hue value based on the attribute category of a product to be calculated. In other words, every product is represented by a color. For example, a can of a first brand A is green, and a purse of a second brand B is red. The Saturation value relates to color saturation, and is fixed to be 1, which represents the most vivid color. The color transformation unit 131 takes the Saturation value as 1 in the subsequent calculation. The normalized attribute value obtained by normalizing the product basic data (e.g., through a normalized product turnover rate matrix, normalized product weight matrix and normalized product volume matrix) is substituted into the Value, which represents the brightness variation and ranges from 0 to 1. The brightness is determined based on the product characteristics (e.g., turnover rate, weight and volume). Lastly, the color transformation unit 131 calculates the hue value, saturation value and the brightness value to obtain color that represents the product. For example, a certain color is used to represent a product, and the brightness represents the product characteristics. The attribute value obtained in FIG. 5 is represented with different color. In an embodiment, the warehouse statuses include the length, width and height of the warehouse bins, an aisle width, the number of product racks and the number of the warehouse bins. Therefore, the warehouse space data transformation unit 132 can obtain the location relation of the warehouse bins, the aisle and the product racks based on the warehouse space data, such as an aisle disposing between two product racks and the number of warehouse bins that product racks on two sides of the aisle have. The length, width and height of each warehouse bin can be set, to get to know the size of the warehouse, the number of the warehouse bins and their location relation. As shown in FIG. 4C, the warehouse space data transformation unit 132 further records the name of a warehouse section and product data stored in the warehouse section. In addition to the warehouse status, the name of each warehouse section (e.g., a code) and the product data stored in the warehouse section (e.g., the can of the first brand A) are also recorded. Therefore, when drawing the overall structure, the warehouse structure drawing unit 133 can correspond each warehouse section to its content. The location relation can be defined by a coordination method. For example, an initial point is established, and the coordinate of the warehouse bins is defined through XY axes vector locations.

The warehouse structure drawing unit 133 substitutes the product color information representing the product status into the warehouse structure information representing the warehouse status, to allow each warehouse bin to be represented based on the difference of the warehouse bins with different color. The warehouse structure drawing unit 133 draws the product racks, substitutes the product into the coordinate in the warehouse space based on the color brightness, and draws the warehouse bins points, to identify the location relation of the warehouse bins in the warehouse. Through the substitution of the product color information, the product status is represented with color within the warehouse bins points, and the difference of the product characteristics (e.g., turnover rate, weight and volume) correspond to different color. FIG. 4C illustrates drawing the warehouse structure. The warehouse structure drawing unit 133 receives the name of the warehouse section provided by the warehouse space data transformation unit 132, the product data stored in the warehouse section and the warehouse status, and obtains the warehouse section attributes including the height, width, depth and name of the warehouse section. Then, the warehouse structure drawing unit 133 constructs product rack attributes including the number of warehouse sections in a single row of product rack and the number of layers of the product racks through the warehouse section attributes, and uses the warehouse section attributes and the product rack attributes to construct the warehouse area attributes including the number of product racks of the warehouse bins, the aisle width between two product racks, and a transverse aisle width. The warehouse structure drawing unit 133 uses corresponding information obtained from the warehouse area attributes and the attribute values of the products obtained by the color transformation space 131 to draw the warehouse bins arrangement status, i.e., the absolute coordinate (x, y, z) of the warehouse sections and the product racks, which are displayed by the front-end displaying device 3.

In another embodiment, the system 1 for arranging warehouse bins visually is connected to the front-end displaying device 3. The front-end displaying device 3 displays the visualized warehouse bins arrangement status generated by the warehouse structure drawing unit 133 with a color graph, and the warehouse manager and/or the operators can obtain the visualized warehouse bins arrangement status quickly and intuitively to further arrange and adjust the warehouse bins.

In another embodiment, the system 1 for arranging warehouse bins visually is connected to the optimized warehouse bins distribution system 4, and the optimized warehouse bins distribution system 4 optimizes the warehouse bins arrangement. The warehouse bins arrangement can also be optimized by artificial intelligence (AI) techniques or an empirical law. In an embodiment, the locations of the products arranged in the warehouse bins are adjusted based on the warehouse manager's experiences.

The visual arrangement of the warehouse bins is illustrated in the following paragraph.

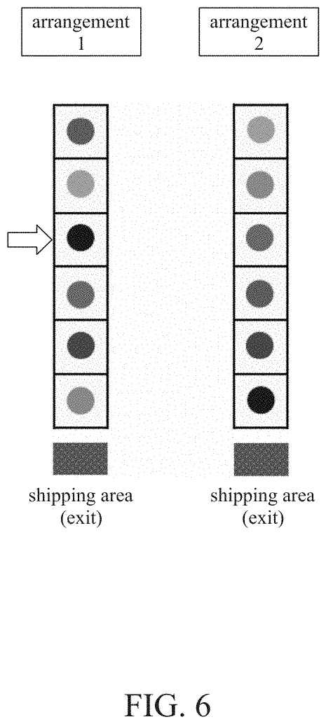

FIG. 6 schematically illustrates a first embodiment relating to arranging warehouse bins visually according to the present disclosure. FIG. 6 shows a one-dimension visual representation, in which one layer has single row. The turnover rate of the products placed in the warehouse bins is represented by the same color series with different darkness, e.g., the darker the color, the higher the turnover rate, and the lighter the color, the lower the turnover rate. As shown in FIG. 6, arrangement 1 and arrangement 2 are two different warehouse bins arrangements. In the arrangement 1, the products denoted by the arrow have a high turnover rate, but the warehouse bins where the products are placed are away from the exit. It can be thus determined that the arrangement 1 results in poor shipping efficiency. In the arrangement 2, the products that have a high turnover rate are placed close to the exit, i.e., the closer the products are to the exit, the darker the color becomes. Therefore, the arrangement 2 corresponds to better shipping efficiency.

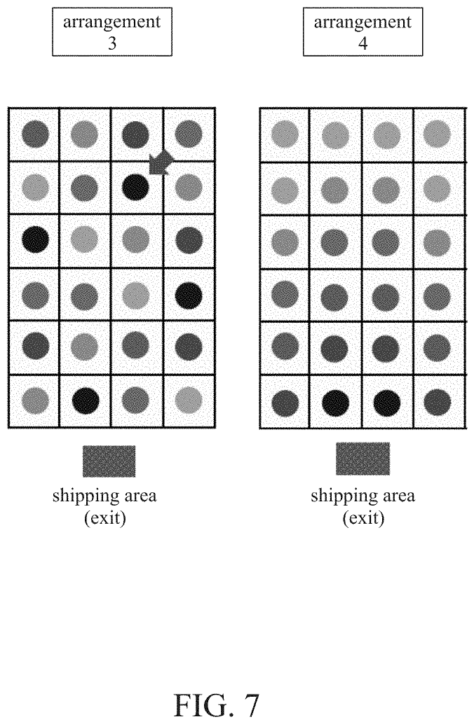

FIG. 7 schematically illustrates a second embodiment relating to arranging warehouse bins visually according to the present disclosure. FIG. 7 shows a two-dimension visual representation, in which one layer has a plurality of rows. The turnover rate of the products placed in the warehouse bins is represented by the same color series with different darkness, e.g., the darker the color, the higher the turnover rate, and the lighter the color, the lower the turnover rate. As shown in FIG. 7, in the arrangement 3 the products denoted by the arrow have a high turnover rate, but the warehouse bins where the products are placed are away from the exit. It can be thus determined that the arrangement 3 results in poor shipping efficiency. In the arrangement 4, the closer the products are to the exit, the darker the color becomes (changing layer by layer). Therefore, the arrangement 4 indicates that the products that have a high turnover rate are placed close to the exit, and corresponds to better shipping efficiency.

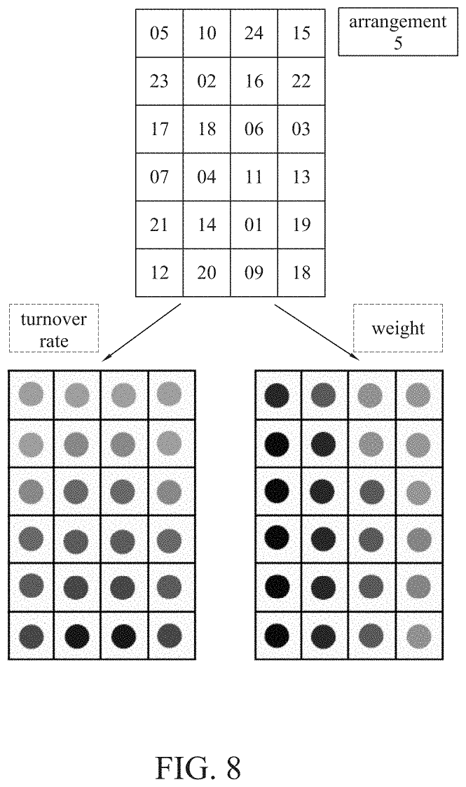

FIG. 8 schematically illustrates a third embodiment relating to arranging warehouse bins visually according to the present disclosure. FIG. 8 shows that the product warehouse bins arrangement representation displays a plurality of product characteristics, such as weight and turnover rate, which are represented by different color series. As shown in FIG. 8, in arrangement 5 the number in the warehouse bins represents the reference numeral of the products, and the product distribution characteristics are represented with different color series. For example, the color darkness on the left represents the turnover rate of the warehouse bins, and the color darkness on the right represents the weight of a single product of the warehouse bins. As described previously, the darker the color, the higher the turnover rate or the heavier the product. As the products that have a high turnover rate or are heavy are placed close to the exit, the product picking time and labor cost are reduced.

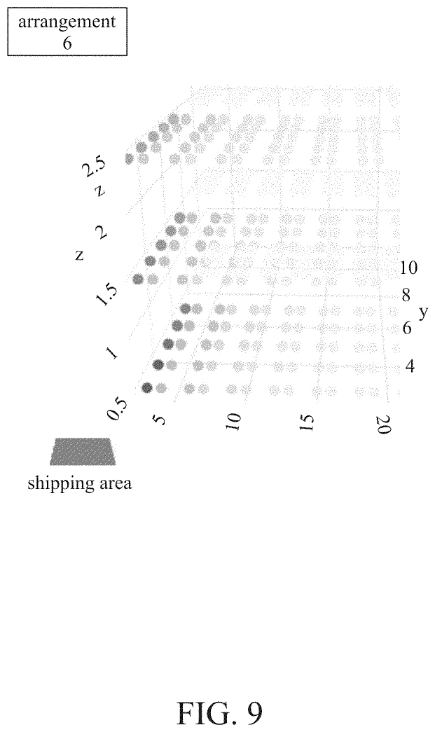

FIG. 9 schematically illustrates a fourth embodiment relating to arranging warehouse bins visually according to the present disclosure. FIG. 9 shows a three-dimension visual representation, in which each of a plurality of layers has a plurality of rows. The turnover rate of the products in the warehouse bins is represented by the same color series, the darker the color, the higher the turnover rate. As shown in FIG. 9, in arrangement 6 the products that have a high turnover rate are placed close to the exit (the color becomes darker as the products are placed close to the left), which is advantageous in picking the products.

It is known from the above that through the visualized warehouse bins arrangement status, the product arrangement distribution can be examined quickly, allowing the warehouse manager to know the arrangement of the whole warehouse quickly and adjust the warehouse bins arrangement in real time. The difference of the product attributes is represented by different color, allowing the warehouse manager to understand the status of each of the warehouse bins intuitively. Compared with the conventional digit representation, the color representation according to the present disclosure can reflect how to adjust the warehouse bins directly, allowing a non-warehouse manager (e.g., the boss) to understand the warehouse bins arrangement easily.

In the system and method for arranging warehouse bins visually according to the present disclosure, the warehouse bins arrangement, not only overcome the disadvantages of conventional digit representation, but also can be examined and managed intuitively through the visualized warehouse bins arrangement status. The system for arranging warehouse bins visually according to the present disclosure analyzes every aspect of the product data in real time and in multiple dimensions, and displays the attribute value of every aspect with a color graph. The visualized warehouse bins arrangement status can optimize the warehouse bins arrangement through AI techniques or an empirical law. Therefore, the present disclosure provides visualized warehouse bins arrangement and simplifies subsequent warehouse management.

It will be apparent to those skilled in the art that various modifications and variations can be made to the disclosed embodiments. It is intended that the specification and examples be considered as exemplary, with a true scope of the present disclosure being indicated by the following claims and their equivalents.

What is claimed is:

1. A system for arranging warehouse bins visually, comprising:
a calculation module configured for normalizing product basic data based on product characteristics to generate normalized product data;
a warehouse module configured for storing the normalized product data; and
a visualization module, comprising:
a color transformation unit configured for generating product color information corresponding to a product status based on the normalized product data;
a warehouse space data transformation unit configured for generating warehouse structure information corresponding to a warehouse status based on warehouse space data; and
a warehouse structure drawing unit configured for combining the product color information with the warehouse structure information to obtain an arrangement status of visualized warehouse bins.

2. The system of claim 1, wherein the product basic data and the warehouse space data are from a warehouse database.

3. The system of claim 1, wherein the calculation module is further configured for normalizing a product characteristics normalized matrix of the product basic data.

4. The system of claim 1, wherein the product characteristics comprise a turnover rate, weight or volume.

5. The system of claim 1, wherein the normalized product data is an attribute value ranging from 0 to 1, and the color transformation unit represents a difference of the product characteristics based on the attribute value with different colors.

6. The system of claim 1, wherein the color transformation unit generates color representing a product by finding a corresponding hue value with a product attribute category of the product basic data, defining a degree of saturation to be one, and substituting an attribute value of the normalized product data with a brightness value using HSV color space transformation.

7. The system of claim 1, wherein the warehouse status comprises a length, a width, a height, an aisle width, a number of product racks or a number of warehouse bins.

8. The system of claim 1, wherein the warehouse space data transformation unit enables each warehouse section to correspond to its product through the warehouse status pre-stored, a warehouse section name and product data stored in the warehouse section.

9. The system of claim 1, wherein the warehouse structure drawing unit combines the product color information representing the product status with the warehouse structure information representing the warehouse status, and represents the warehouse bins of the warehouse structure information with different colors based on the difference of the product characteristics.

10. The system of claim 1, wherein the warehouse structure drawing unit obtains warehouse section attributes based on the warehouse section name provided by the warehouse space data transformation unit, the product data stored in the warehouse section and the warehouse status, constructs product rack attributes based on the warehouse section attributes, constructs warehouse area attributes based on the warehouse section attributes and the product rack attributes, and draws the visualized warehouse bins arrangement status with the attribute value of the product obtained by the warehouse area attributes and the color transformation space.

11. The system of claim 1, further comprising a front-end displaying device configured for displaying the visualized warehouse bins arrangement status generated by the warehouse structure drawing unit with a color graph.

12. The system of claim 1, wherein the visualized warehouse bins arrangement status is transmitted to an optimized warehouse bins distribution system optimizing warehouse bins arrangement.

13. A method for arranging warehouse bins visually, comprising:
providing product basic data and warehouse space data;
normalizing the product basic data based on product characteristics to generate normalized product data;
generating product color information corresponding to a product status based on the normalized product data;
generating warehouse structure information corresponding to a warehouse status based on the warehouse space data; and
combining the product color information with the warehouse structure information to obtain visualized warehouse bins arrangement status when the product color information is added to the warehouse structure information.

14. The method of claim 13, wherein the product basic data is normalized through a product characteristics normalized matrix.

15. The method of claim 13, wherein the normalized product data is an attribute value ranging from 0 to 1, and different values represent a difference of the product characteristics with different colors.

16. The method of claim 13, wherein combining the product color information with the warehouse structure information comprises combining the product color information representing the product status with the warehouse structure information representing the warehouse status, and the warehouse bins of the warehouse structure information are represented with different colors based on the difference of the product characteristics.

17. The method of claim 13, further comprising transmitting the visualized warehouse bins arrangement status to a front-end displaying device.

18. The method of claim 13, further comprising transmitting the visualized warehouse bins arrangement status to an optimized warehouse bins distribution system optimizing warehouse bins arrangement.

19. The method of claim 13, wherein generating the product color information corresponding to the product status based on the normalized product data comprises:
obtaining a corresponding hue value from a predetermined hue value based on a product attribute category of the product basic data;
defining a degree of saturation to be one;
substituting an attribute value of the normalized product data with a brightness value; and
using the hue value, the degree of saturation and the brightness value through a HSV color space to generate color representing a product.

20. The method of claim 13, wherein generating the warehouse structure information corresponding to the warehouse status based on the warehouse space data further comprises corresponding each warehouse section to its product through the warehouse status pre-stored, a warehouse section name and product data stored in the warehouse section.

21. The method of claim 20, wherein combining the product color information with the warehouse structure information to obtain visualized warehouse bins arrangement status when the product color information is added to the warehouse structure information comprises:
obtaining warehouse section attributes of the warehouse section based on the warehouse section name, the product data stored in the warehouse section and the warehouse status;
constructing product rack attributes based on the warehouse section attributes; and
constructing warehouse area attributes based on the warehouse section attributes and the product rack attributes, and drawing the visualized warehouse bins arrangement status through the warehouse area attributes and the attribute value.
